(19) United States
(12) Patent Application Publication
(10) Pub. No.: US 2021/0299999 A1
(43) Pub. Date: Sep. 30, 2021

(54) GLASS-MAT TILE BACKER PANEL AND MANUFACTURING PROCESS OF A GLASS-MAT TILE BACKER PANEL

(71) Applicant: UNITED STATES GYPSUM COMPANY, Chicago, IL (US)

(72) Inventors: Michael P. Shake, Johnsburg, IL (US); Yanfei Peng, Hawthorne Woods, IL (US); Jeffrey William Donelan, Libertyville, IL (US)

(73) Assignee: UNITED STATES GYPSUM COMPANY, CHICAGO, IL (US)

(21) Appl. No.: 17/203,381

(22) Filed: Mar. 16, 2021

Related U.S. Application Data
(60) Provisional application No. 63/002,619, filed on Mar. 31, 2020.

(51) Int. Cl. B32B 13/14; B32B 5/02; C04B 28/14

(52) U.S. Cl. CPC B32B 13/14; B32B 5/022; C04B 28/14; B32B 2262/02; B32B 2262/101; B32B 2260/046; B32B 2255/02; B32B 2307/7265; B32B 2607/00; B32B 2260/021; B32B 2255/26

(57) ABSTRACT

A gypsum tile backer panel with a pre-impregnated or pre-coated nonwoven fiber face mat. Methods for manufacturing these gypsum tile backer panel which include applying a gypsum slurry to a pre-impregnated or pre-coated nonwoven fiber face mat are also provided. A gypsum tile backer panel system employing the gypsum tile backer panel is also provided.

### FIELD OF THE INVENTION

This invention relates to a glass-mat tile backer panel having a gypsum core and methods for manufacturing and installing the panel.

### BACKGROUND OF THE INVENTION

U.S. Pat. No. 10,399,898 to Peng et al discloses hydrophobic finish compositions and cementitious articles made with the hydrophobic finish compositions. In some embodiments, the article is a waterproof gypsum panel that is surface reinforced with inorganic mineral fibers that face a flexible and hydrophobic cementitious finish possessing beneficial waterproofing properties. These waterproof gypsum panels have many uses, such as, tile backer board in wet or dry areas of buildings, exterior weather barrier panel for use as exterior sheathing, interior wall and ceiling, and roof cover board having water durability and low surface absorption. The flexible and hydrophobic cementitious finish can include fly ash, film-forming polymer, preferably silane compound (e.g., alkyl alkoxysilane), an extended flow time retention agent including either one or more carboxylic acids, salts of carboxylic acids, or mixtures thereof, and other optional additives. Preferably a pre-coated non-woven glass fiber mat is employed to provide the inorganic mineral fibers for the surface reinforcement. However, the panels are made by locating the gypsum core between two glass mat sheets and then allowing this gypsum core to set. After the gypsum core sets, then the hydrophobic finish is applied.

However, applying a hydrophobic finish after a board sets adds to manufacturing time and complexity. There remains a desire for a faster method to produce glass-mat tile backer panel.

### BRIEF SUMMARY OF THE INVENTION

The invention provides a panel that is a baseboard/mat combination that provides water resistance without post processing the panel.

The invention relates to an improved gypsum glass-mat tile backer panel having a hydrophobic surface and a method for making same. In particular, the invention provides gypsum glass-mat tile backer panel comprising:

a gypsum core layer having front and rear surfaces, the gypsum core layer having a thickness of 0.25 to 1.25, preferably 0.25 to 0.625, inches, wherein the gypsum core layer comprises at least 75 wt. % calcium sulfate material;

a first nonwoven fibrous mat having opposed first and second sides, the second side facing the gypsum core, wherein the second side of the first nonwoven fibrous mat is attached to the front surface of the gypsum core layer;

wherein the first nonwoven fibrous mat comprises at least one of polymer fibers, glass fibers, mineral fibers or a combination thereof, and a hydrophobic binder, wherein the hydrophobic binder comprises a first polymer, and optionally an inorganic filler, and optionally a second polymer binder;

wherein when deposited the mat has a surface water absorption of less than 0.5 grams per ASTM C1178/C1178M-18 Standard Specification for Coated Glass Mat Water-Resistant Gypsum Backing Panel 1.1;

a second nonwoven fibrous mat, wherein the second nonwoven fibrous mat is attached as a rear cover sheet to the rear surface of the gypsum core layer, wherein the second nonwoven fibrous mat comprises at least one of polymer fibers, glass fibers, mineral fibers or a combination thereof,

wherein the first and second nonwoven fibrous mats have an absence of paper fibers and an absence of cellulose fibers.

The invention also provides methods of preparing the gypsum non-woven fiber mat tile backer panel of the invention described in the present disclosure comprising:

depositing a first nonwoven fibrous mat as a face mat onto a moving surface, wherein when deposited the first nonwoven fibrous mat has opposed first and second sides, the first side facing away from the moving surface;

wherein when deposited the first nonwoven fibrous mat comprises a substrate of non-woven fibers selected from at least one of polymer fibers, glass fibers, mineral fibers or a combination thereof, and a hydrophobic material pre-impregnated or pre-coated on the mat;

wherein when deposited the mat has a surface water absorption of less than 0.5 grams per ASTM C1178/C1178M-18 Standard Specification for Coated Glass Mat Water-Resistant Gypsum Backing Panel 1.1;

mixing at least water and calcium sulfate material to prepare an aqueous gypsum slurry comprising at least 75 wt. % calcium sulfate material on a dry (water free) basis, wherein said calcium sulfite material comprises calcium sulfate hemihydrate;

applying the aqueous gypsum slurry in a bonding relation to the second side of the first nonwoven fibrous mat to form a gypsum core layer, the gypsum core layer having a face side and a back side, wherein the gypsum core layer face side faces the face mat;

applying a second nonwoven fibrous mat as a back mat on the back side of the gypsum core layer to form a board preform, thereby locating the aqueous slurry between the face mat and the back mat, wherein the second nonwoven fibrous mat comprises at least one of polymer fibers, glass fibers, mineral fibers or a combination thereof; and

allowing the aqueous gypsum slurry located between the face mat and the back mat to set, thereby forming the gypsum tile backer panel;

wherein the first and second nonwoven fibrous mats have an absence of paper fibers and an absence of cellulose fibers.

To facilitate manufacture the method supplies to the production line a pre-coated or pre-impregnated facer mat for which the surface water absorption of the finished product having the mat (glass mat or other mat suitable in the invention) is less than 0.5 grams per ASTM C1178/C1178M-18 Standard Specification for Coated Glass Mat Water-Resistant Gypsum Backing Panel 1.1. The mat having the specified surface water absorption when deposited may be achieved by pre-impregnating a mat or pre-coating a mat with a uniform distribution of hydrophobic material which may or may not contain a filler.

Typical impregnated mat has the following composition (by weight %):
Continuous filament glass fiber 20-60%
Binder polymer, such as cured polyvinyl alcohol 1-10% or 2-10%
Hydrophobic impregnating material polymer, for example cured acrylic polymer, 1-10% or 2-10%
Mineral filler 40-70% in the hydrophobic impregnating material

Typical coated mat has the following composition (by weight %):
Continuous filament glass fiber 15-35%
Cured urea-formaldehyde resin 1-10% or 2-10% provided as binder
Polymer, for example, cured acrylic polymer, 1-10% or 2-10% provided as hydrophobic coating
Mineral filler 45-75%

Typically, the hydrophobic finish (of polymer and filler) is 5-80% of the weight of the first nonwoven fibrous mat fibers and binder (thus based on the weight of the mat absent any coating), more preferably 10-70% of the weight, typically 40-70% or 15-40% of the weight, e.g., 25 to 40% of the weight.

The hydrophobic finish is pre-applied to the mat in a single or multiple steps and each step may apply different chemistries optionally containing a filler and will provide water resistance. The term “pre-impregnated” or “pre-coated” with hydrophobic material is employed to present a mat that has been impregnated or coated with a hydrophobic material with sufficient volume so as to impart a hydrophobic finish on the finished product. For purposes of this description impregnating the glass-mat is defined as placing a layer of the hydrophobic material (hydrophobic finish) on the glass mat such that at least a portion of the hydrophobic material (hydrophobic finish) penetrates a depth into the glass-mat fibers. Coating the glass-mat is defined as placing a layer of the hydrophobic material (hydrophobic finish) on top of the glass-mat to be on a surface of a glass-mat with no penetration into the glass-mat.

The term “pre-impregnated” is employed to present a mat that has been filled or impregnated with a sufficient volume of hydrophobic material, such as polymers, silanes, siloxanes, fluorides, or polymers with hydrophobic functional groups, so as to impart a hydrophobic finish on the finished product. The hydrophobic materials typically have an absence of fly ash and/or an absence of hydraulic materials.

Impregnation can be completed “in-situ” during manufacturing of the mat in a one step process. Additionally, impregnation could be completed in additional processing steps where binder is introduced or penetrated into the mat through chemical or mechanical methods. Chemical methods would include, but not be limited to, modification of the binder or mat surface chemistry and binder viscosity. Mechanical methods could include, but are not limited to pressure, vacuum, or gravity. The resulting microstructure may lead to a uniform distribution of material or a gradient from one surface. This pre-impregnating may be done in multiple steps with the same or different polymer optionally containing a filler.

Alternately, the mat having the specified surface water absorption when deposited may be achieved by pre-coating the mat with hydrophobic materials, such as polymers, silanes, siloxanes, fluorides, or polymers with hydrophobic functional groups. The hydrophobic materials typically have an absence of fly ash and/or an absence of hydraulic materials.

In the product and the method of the invention, the rear mat (also known as rear cover sheet or back facer) is always partially embedded to bond the rear mat to the gypsum panel core. The slurry penetration into the rear mat ranges from 40 to 60% of the mat thickness.

The gypsum core of the gypsum panel comprises set gypsum, namely calcium sulfate dihydrate resulting from setting the aqueous gypsum slurry comprising calcium sulfate hemihydrate and optionally calcium sulfate anhydrite. Typically, when the calcium sulfate material and water are mixed, the resulting aqueous gypsum slurry has at least 75 wt. %, preferably at least 85 wt. %, most preferably at least 95 wt. %, on a dry basis calcium sulfate hemihydrate (also known a stucco or calcined gypsum). In other words, the aqueous gypsum slurry is at least 75 wt. %, preferably at least 85 wt. %, most preferably at least 95 wt. %, on a dry basis calcium sulfate hemihydrate prior to setting.

In another aspect, the present disclosure is directed to a tile system comprising framing to which is attached at least one tile backer panel of the invention which prevents water penetration. In particular, the back side of the tile backer panel faces towards the framing and tiles are applied to the front side of the tile backer panel with tile adhesive. The framing is of wood, metal or any other building framing material. The tile backer panels are attached to the framing by screws, nails, glue, or other building fasteners. Preferably the tile backer panel has no perforations except for perforations made by the screws or nails.

These and other advantages of the present invention, as well as additional inventive features, will be apparent from the description of the invention provided herein.

### BRIEF DESCRIPTION OF THE DRAWINGS

FIG. 1 shows a perspective view of a first example of a gypsum tile backer panel of the present invention with a moisture resistant, nonwoven, glass fiber mat as a face mat on its gypsum core.

FIG. 2 shows a side cross sectional view of the gypsum tile backer panel of FIG. 1.

FIG. 3 shows a schematic diagram of a tile backer panel of the present invention having pre-coated front and rear facers.

FIG. 4 shows a schematic diagram of a tile backer panel of the present invention having a pre-coated front facer and an uncoated rear facer.

FIG. 5 shows a pre-coated nonwoven glass fiber mat.

FIG. 6 shows a diagrammatic side view of an example of a wet end of a continuous manufacturing line for producing a tile backer panel of the invention.

FIG. 7 shows a perspective view of a wall system of the present invention including the tile backer panel of the present invention attached to one side of a metal stud wall.

### DETAILED DESCRIPTION OF THE INVENTION

The present invention is a tile backer panel (also known as tile backer board) having a gypsum core and a hydrophobic or water resistant front surface. For purposes of this specification the terms “board” and “panel” are interchangeable. A hydrophobic finish is required for the final product. This could be through a hydrophobic coating pre-applied to the mat or a hydrophobic binder with sufficient volume percent in the mat.

In particular, the invention provides gypsum glass-mat tile backer panel comprising:

a gypsum core layer having front and rear surfaces, the gypsum core layer having a thickness of 0.25 to 1.25, preferably 0.25 to 0.625, inches, wherein the gypsum core layer comprises at least 75 wt. % calcium sulfate material;

a first nonwoven fibrous mat having opposed first and second sides, the second side facing the gypsum core, wherein the second side of the first nonwoven fibrous mat is attached to the front surface of the gypsum core layer;

wherein the first nonwoven fibrous mat comprises at least one of polymer fibers, glass fibers, mineral fibers or a combination thereof, and a hydrophobic binder, wherein the hydrophobic binder comprises a first polymer, and optionally an inorganic filler, and optionally a second polymer binder;

wherein when deposited the mat has a surface water absorption of less than 0.5 grams, preferably less than 0.1 grams, per ASTM C1178/C1178M-18 Standard Specification for Coated Glass Mat Water-Resistant Gypsum Backing Panel 1.1;

a second nonwoven fibrous mat, wherein the second nonwoven fibrous mat is attached as a rear cover sheet to the rear surface of the gypsum core layer, wherein the second nonwoven fibrous mat comprises at least one of polymer fibers, glass fibers, mineral fibers or a combination thereof,

wherein the first and second nonwoven fibrous mats have an absence of paper fibers and an absence of cellulose fibers.

The invention also provides methods of preparing the gypsum non-woven fiber mat tile backer panel of the invention described in the present disclosure comprising:

depositing a first nonwoven fibrous mat as a face mat onto a moving surface, wherein when deposited the first nonwoven fibrous mat has opposed first and second sides, the first side facing away from the moving surface;

wherein when deposited the first nonwoven fibrous mat comprises a substrate of non-woven fibers selected from at least one of polymer fibers, glass fibers, mineral fibers or a combination thereof, and a hydrophobic material pre-impregnated or pre-coated on the mat;

wherein when deposited the mat has a surface water absorption of less than 0.5 grams, preferably less than 0.1 grams, per ASTM C1178/C1178M-18 Standard Specification for Coated Glass Mat Water-Resistant Gypsum Backing Panel 1.1;

mixing at least water and calcium sulfate material to prepare an aqueous gypsum slurry comprising at least 75 wt. % calcium sulfate material on a dry (water free) basis, wherein said calcium sulfite material comprises calcium sulfate hemihydrate;

applying the aqueous gypsum slurry in a bonding relation to the second side of the first nonwoven fibrous mat to form a gypsum core layer, the gypsum core layer having a face side and a back side, wherein the gypsum core layer face side faces the face mat;

applying a second nonwoven fibrous mat as a back mat on the back side of the gypsum core layer to form a board preform, thereby locating the aqueous slurry between the face mat and the back mat, wherein the second nonwoven fibrous mat comprises at least one of polymer fibers, glass fibers, mineral fibers or a combination thereof; and

allowing the aqueous gypsum slurry located between the face mat and the back mat to set, thereby forming the gypsum tile backer panel;

wherein the first and second nonwoven fibrous mats have an absence of paper fibers and an absence of cellulose fibers.

Typically, the hydrophobic finish (of polymer and filler) is 5-80% of the weight of the first nonwoven fibrous mat fibers and binder (thus based on the weight of the mat absent any coating), more preferably 10-70% of the weight, typically 40-70% or 15-40% of the weight, e.g., 25 to 40% of the weight.

The rear mat is always partially embedded to bond the back facer to the panel core. The slurry penetration into the mat typically ranges from 30 to 60% of the mat thickness.

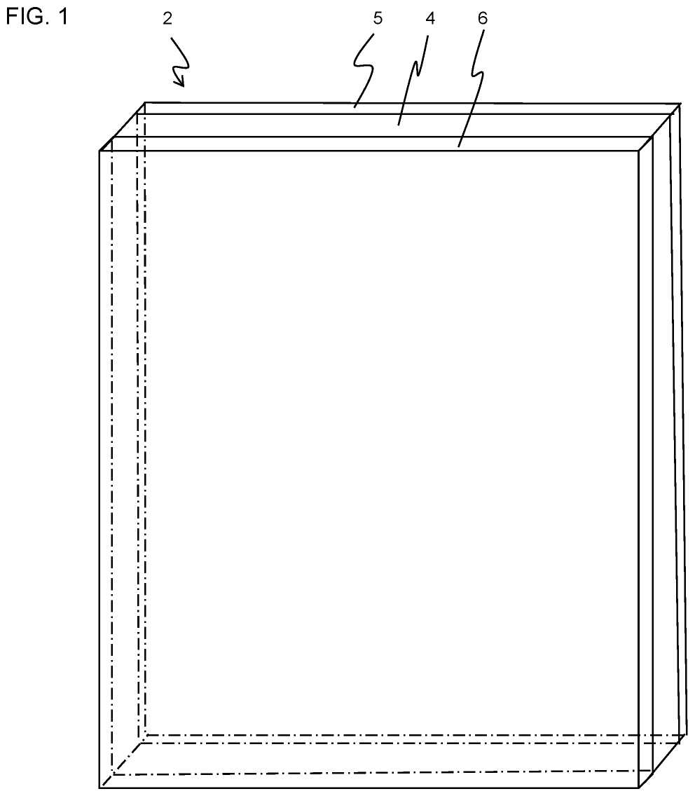

FIG. 1 shows a perspective view of a tile backer panel 2 of the present invention which is a gypsum panel. The gypsum tile backer panel 2 has a gypsum core 4, front facing 5 on its front side, and rear facing 6 on its rear side. The front facing 5 is a non-woven glass fiber mat with desired water resistance. The rear facing 6 is a non-woven glass fiber mat that is uncoated or pre-coated. However, instead of glass fibers other fibers may also be suitable for the mat.

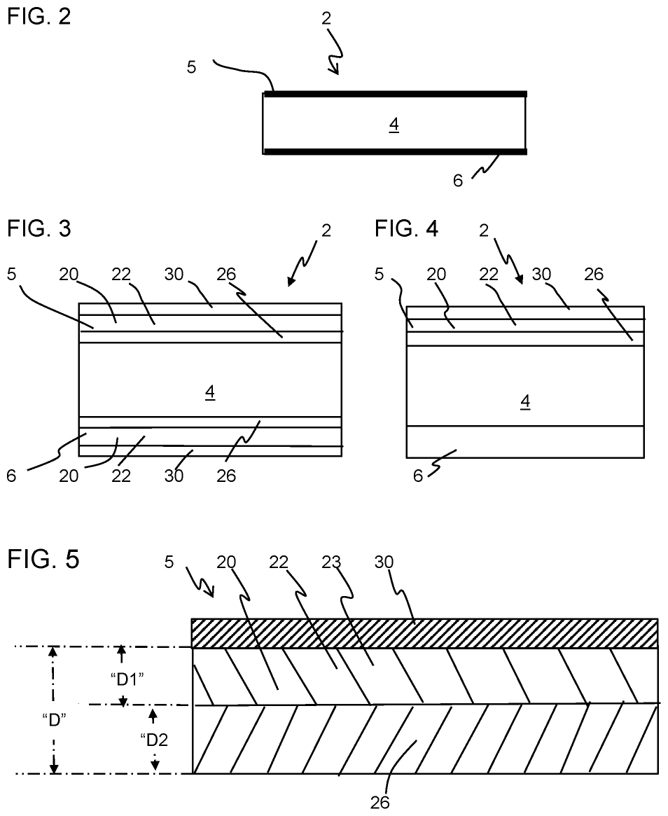

FIG. 2 shows a cross-sectional view of the gypsum tile backer panel 2 of the present invention of FIG. 1. The core 4 of the gypsum tile backer panel 2 comprises set gypsum, namely calcium sulfate dihydrate. This results from setting a gypsum slurry comprising calcium sulfate hemihydrate.

FIG. 3 shows in more detail a schematic of a first version of the tile backer panel 2 of FIG. 1 employing pre-coated glass mat. The tile backer panel 2 comprises the gypsum core 4, two pre-coated fibrous mats 5, 6 as front facing and rear facing, respectively. Each of the pre-coated fibrous mats 5, 6 comprising a glass substrate 20 having a coated portion 22 coated with polymer, an uncoated portion 26, as well as a coating 30 of hydrophobic finish composition overlaying the coated portion 22. The gypsum core 4 has over 50 wt. % gypsum on a dry basis. Typically at least 75 wt. %, preferably at least 85 wt. %, most preferably at least 95 wt. %, calcium sulfate dihydrate on a dry basis. Optionally the gypsum core 4 further comprises other additives.

FIG. 4 illustrates a schematic diagram of a second version of the tile backer panel 2 of FIG. 1 comprising a gypsum core 4 and two fibrous mats 5, 6. The first fibrous mat 5 comprising a glass substrate 20, coated portion 22 coated with polymer and uncoated portion 26, as well as a coating 30 of the hydrophobic finish composition overlaying the coated portion 22. The second fibrous mat 6 of the tile backer panel 2 is uncoated.

FIG. 5 shows a cross section of the coated glass mat 5 comprising a glass substrate 20 having the coated portion 22 coated with polymer 23, the uncoated portion 26, as well as the coating 30 of hydrophobic finish composition overlaying the coated portion 22 for use in the present invention. The measured thickness of the coating penetration for the coated portion 22 is depicted by arrow “D1”. This thickness dimension (represented by “D1”) of the coated portion 22 of coated glass mat 5 is about 0.002-0.050 inches (2-50 mil). The thickness of the portion 26 remaining uncoated is labeled by arrow “D2”. These dimensions particularly apply to a coated portion extending 10-75% through the thickness of a coated mat wherein the mat thickness “D” is 0.015-0.065 (15-65 mil). The coating 30 of hydrophobic finish composition overlaying the coated portion 22 may also penetrate into the polymer coated portion 22 of the glass substrate 20, but for clarity this is not shown in the figure.

Fibrous Mat Facings

The first fibrous mat and second fibrous mat facings (also known as cover sheets) are located at the faces of the tile backer panels of the present invention. It will be appreciated that each fibrous mat has two facing surfaces: an outwardly facing surface and a surface facing the gypsum core. The fibrous mats are non-woven. Suitable fibrous mats include commercially available mats used as facing materials for gypsum tile backer panels.

The first fibrous mat and second fibrous mat respectively comprise fibrous material selected from at least one of polymer fibers, glass fibers, mineral fibers or a combination thereof. The first fibrous mat and second fibrous mats have an absence of paper fibers and an absence of cellulose fibers.

Preferably the first fibrous mat and second fibrous mat of the tile backer panels are respectively fibrous material selected from at least one of polymer fibers, glass fibers, mineral fibers or a combination thereof. More preferably the gypsum tile backer panels of the invention as a whole have an absence of paper and an absence of cellulose, particularly an absence of cellulose fibers.

The fibrous mat can comprise any suitable type of polymer fiber, glass fiber, mineral fiber, or combination thereof. The choice of fibers will depend, in part, on the type of application in which the gypsum tile backer panel is to be used. For example, when the gypsum tile backer panel is used for applications that require heat or fire resistance, appropriate heat or fire resistant fibers should be used in the fibrous mat.

Mineral fibers are fibrous inorganic substances made primarily from rock, clay, slag, or glass. These fibers are classified into three general groups: fiberglass (glass wool and glass filament), mineral wool (rock wool and slag wool), and refractory ceramic fibers (RCF).

Examples of fiber materials suitable for use in the fibrous mat include, but are not limited to, glass fibers, polyamide fibers, polyaramid fibers, polypropylene fibers, polyester fibers (e.g., polyethylene terephthalate (PET)), polyvinyl alcohol (PVOH), polyvinyl acetate (PVAc), and combinations thereof. Preferably the fibers consist of coated or uncoated glass fibers (also known as coated or uncoated fiberglass).

Typically the fibers consist of coated or uncoated alkaline resistant glass fibers (also known as coated or uncoated alkaline resistant fiberglass). Generally the non-woven fibrous mat has an absence of paper fibers and an absence of cellulose fibers.

The surface water absorption of the mat is less than 0.5 grams, preferably less than 0.1 grams, per ASTM C1178/C1178M-18 Standard Specification for Coated Glass Mat Water-Resistant Gypsum Backing Panel 1.1.

The invention provides a mat with sufficient water resistance to be a tile backer board while retaining enough vapor penetration to maintain bond to the core. The porosity of the coated mat is sufficiently low that it is not permeable to cementitious, for example gypsum, slurry. However, when gypsum slurry is employed the porosity is also sufficient to allow water vapor to escape from the gypsum slurry when heated. Thus, the hydrophobic finish provides the mat with porosity sufficient to allow water vapor to escape from the gypsum slurry when heated.

The finish desirably has a degree of hydrophobicity such that water applied to the finish surface exhibits a contact angle of about 30° or greater (e.g., about 40° or greater), such as about 30° to about 120°, or about 50° to about 100° The contact angle can be measured by any suitable technique.

To achieve the specified surface water absorption the mat is pre-coated or pre-impregnated with hydrophobic material before the mat is fed to a tile backer panel production line. Thus, the mat is pre-coated or pre-impregnated with a hydrophobic material, such as polymers (for example film forming polymers), silanes, siloxanes, fluorides, or polymers with hydrophobic functional groups, before contacting the gypsum slurry that will become the core of the board. The hydrophobic materials typically have an absence of fly ash and/or an absence of hydraulic materials. For purposes of this specification, calcium sulfate hemihydrate that sets when contacted with water to form the gypsum core is not considered hydraulic material. Typical hydraulic materials are cements, for example Portland cement.

The pre-impregnating or pre-coating may be performed on a variety of mats.

Prior to pre-impregnating or pre-coating hydrophobic material according to the invention, the fibrous mats may be a mat fiber substrate that already has a uniformly distributed binder (typically termed an “uncoated mat” in the art). Such a non-woven “uncoated mat” typically has a small amount of binder uniformly dispersed therethrough. The binder can be any binder typically used in the mat industry. Suitable binders include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. In this case the hydrophobic material may be applied to pre-impregnate or pre-coat this uncoated mat.

In the alternative, prior to including hydrophobic material according to the invention, the fibrous mats may be a mat fiber substrate that has the uniformly distributed binder and a binder coating which is a layer of a polymer binder and optionally filler on a side of the mat that will face away from the gypsum core (typically termed a “pre-coated mat” in the art). In this case the hydrophobic material may be applied to pre-impregnate or pre-coat this “pre-coated mat”. Typically, when applying the hydrophobic material to the “pre-coated mat” the hydrophobic material is applied to the surface of the binder coating. However, the hydrophobic material can be applied to pre-impregnate or pre-coat before the binder-coating is applied.

In addition to the at most small amount of substantially uniformly distributed polymer binder of the uncoated mat, the pre-coated mat has an additional binder coating applied to one side to penetrate at most partially through the thickness of the mat. Thus, an acrylic pre-coated glass mat differs from an “uncoated” glass mat using, for example, acrylic binder. The binder coating uniformly penetrates the glass mat substrate from one side of the coated glass mat to a depth which is a fraction, typically 10 to 75 percent, preferably 25 to 75%, of the thickness of the coated glass mat. The uniformly deep penetration is achieved by one or more coating techniques described in US published patent application no. 2007/0042657 A1 to Bush et al, incorporated herein by reference, which facilitate increased exposure of coating mixture to a glass mat substrate, thereby achieving more uniform coating penetration. Thus, the pre-coated non-woven glass fiber mat has one side coated with the binder coating and hydrophobic finish and the other side uncoated to expose a raw glass fiber side. When employing a pre-coated mat, the hydrophobic finish composition layer is adhered to the coated surface of the coated fibrous mat rather than the raw glass fiber side. The cementitious-based core is adhered to the raw glass fiber side. The non-coated thickness of the coated glass mat is sufficiently thick for bonding purposes with, e.g., a gypsum slurry or other cementitious core materials. However, the non-coated thickness may have the minor amount of polymer binder normally associated with a non-pre-coated fiber mat.

The polymer used in the binder and/or binder coating of the “uncoated mats” and “pre-coated mats” can be any polymer typically used in the mat industry. Suitable polymers include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. Preferably the polymer used in the binder coating is a latex. Examples of polymer latex binders used with the inorganic filler are, but are not limited to: Styrene-Butadiene-Rubber (SBR), Styrene-Butadiene-Styrene (SBS), Ethylene-Vinyl-Chloride (EVCI), Poly-Vinylidene-Chloride (PVdC), modified Poly-Vinyl-Chloride (PVC), Poly-Vinyl-Alcohol (PVOH), Ethylene-Vinyl-Acetate (EVA), Poly-Vinyl-Acetate (PVA), and Styrene-Acrylate (SA).

Hydrophobic Material Compositions

As explained above the hydrophobic material can be pre-applied by pre-impregnating or pre-coating.

The hydrophobic material can be pre-applied to the fibrous mat as a liquid or solid material (e.g., resin, wet-dispersed powder, dry powder, or film) by any of various methods known in the art. For instance, the hydrophobic finish materials can be applied by brushing, spraying, rolling, pouring, dipping, sifting, or overlaying the hydrophobic finish material. Solid materials, such as powders, can be dispersed prior to application using any common solvent (e.g., water, alcohols, etc.) or dispersant, provided the solvent or dispersant does not react adversely with the fibrous mat materials. Solvents that etch surface fibers of the fibrous mat, and thereby enhance the ability of the finish material to adhere to the mat, also can be used. Preferably, any solvent or dispersant used is easily dried and does not leave a residue that prevents the finish from adhering to the fibrous mat. Liquid or dispersed finish materials can have any viscosity suitable for application to the fibrous mat.

Recognizing that the surface of the fibrous mat is an irregular surface, the hydrophobic material need not provide a finish that is completely continuous. When a liquid or powder finish composition is used, for instance, the finish material may fall within the voids between the fibers of the mat leaving gaps or holes in the finish. However, the finish material preferably is applied in an amount sufficient to provide a finish that is continuous and, desirably, coextensive with the dimensions of the first fibrous mat.

Typical hydrophobic materials are any one or more of polymers (for example film forming polymers), silanes, siloxanes, fluorides, or modified polymers with hydrophobic functional groups. The hydrophobic materials typically have an absence of fly ash and/or an absence of hydraulic materials.

Film Forming Polymers

Film-forming polymer may be included as a polymer in the hydrophobic material. The film-forming polymer is preferably made from a pure acrylic, a rubber, a styrene butadiene rubber, a styrene acrylic, a vinyl acrylic, or an acrylated ethylene vinyl acetate copolymer. Preferably film-forming polymer is derived from polymerization of at least one acrylic monomer selected from the group consisting of acrylic acid, acrylic acid esters, methacrylic acid, and methacrylic acid esters. For example, the monomers preferably employed in emulsion polymerization include methyl acrylate, methyl methacrylate, ethyl acrylate, ethyl methacrylate, butyl acrylate, butyl methacrylate, propyl acrylate, propyl methylacrylate, 2-ethyl hexyl acrylate and methacrylate, cyclohexyl acrylate and methacrylate, decyl-acrylate and methacrylate, isodecylacrylate and methacrylate, benzyl acrylate and methacrylate, other acrylates, methacrylates and their blends, acrylic acid, methacrylic acid, styrene, vinyl toluene, vinyl acetate, vinyl esters of higher carboxylic acids than acetic acid, for example, vinyl versatate, acrylonitrile, acrylamide, butadiene, ethylene, vinyl chloride and the like, and mixtures thereof.

Typically, the film-forming polymer comprises one or more of the following: acrylic polymers and copolymers, rubber-based polymers and copolymers such as styrene-butadiene rubber, copolymers of styrene and acrylic, copolymers of vinyl acetate and ethylene, copolymers of vinyl chloride and ethylene, copolymers of vinyl acetate and VeoVa (vinyl ester of versatic acid), copolymers of vinyl laurate and ethylene, terpolymers of vinyl acetate, ethylene and methylmethaacrylate, terpolymers of vinyl acetate, ethylene and vinyl laurate, terpolymers of vinyl acetate, ethylene and VeoVa (vinyl ester of versatic acid), and any combination thereof.

Preferably, the film-forming polymer comprises one or more of the following: acrylic polymers and copolymers, rubber-based polymers and copolymers such as styrene-butadiene rubber, copolymers of styrene and acrylic, copolymers of vinyl acetate and ethylene, copolymers of vinyl chloride and ethylene, copolymers of vinyl acetate and VeoVa vinyl ester of versatic acid (commercially available under the mark VeoVa from Shell Chemical Company), copolymers of vinyl laurate and ethylene, terpolymers of vinyl acetate, ethylene and methyl methacrylate, terpolymers of vinyl acetate, ethylene and vinyl laurate, terpolymers of vinyl acetate, ethylene, and vinyl esters of branched tertiary monocarboxylic acids (e.g. vinyl ester of versatic acid commercially available under the mark VeoVa from Shell Chemical Company or sold as EXXAR neo vinyl esters by ExxonMobil Chemical Company), itaconic acid, crotonic acid, maleic acid, fumaric acid, and ethylene, and any combination thereof.

Commonly used monomers are butyl acrylate, methyl methacrylate, ethyl acrylate and the like. Preferably, the monomers include one or more monomers selected from the group consisting of n-butyl acrylate, methyl methacrylate, styrene, and 2-ethylhexyl acrylate.

The at least one film forming polymer is preferably derived from at least one acrylic monomer selected from the group consisting of acrylic acid, acrylic acid esters, methacrylic acid, and methacrylic acid esters. For example, the at least one film-forming polymer can be a butyl acrylate/methyl methacrylate copolymer or a 2-ethylhexyl acrylate/methyl methacrylate copolymer. For example, the at least one polymer can be a butyl acrylate/methyl methacrylate copolymer or a 2-ethylhexyl acrylate/methyl methacrylate copolymer. Typically, the at least one polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C4-C8 conjugated dienes such as 1,3-butadiene, isoprene or chloroprene.

For example, the at least one film-forming polymer can be a pure acrylic, a styrene acrylic, a vinyl acrylic or an acrylated ethylene vinyl acetate copolymer.

The pure acrylics preferably comprise acrylic acid, methacrylic acid, an acrylate ester, and/or a methacrylate ester as the main monomers). The styrene acrylics preferably comprise styrene and acrylic acid, methacrylic acid, an acrylate ester, and/or a methacrylate ester as the main monomers. The vinyl acrylics preferably comprise vinyl acetate and acrylic acid, methacrylic acid, an acrylate ester, and/or a methacrylate ester as the main monomers. The acrylated ethylene vinyl acetate copolymers preferably comprise ethylene, vinyl acetate and acrylic acid, methacrylic acid, an acrylate ester, and/or a methacrylate ester as the main monomers. The monomers can also include other main monomers such as acrylamide and acrylonitrile, and one or more functional monomers such as itaconic acid and ureido methacrylate, as would be readily understood by those skilled in the art. In a particularly preferred embodiment, the film-forming polymer is a pure acrylic such as a butyl acrylate/methyl methacrylate copolymer derived from monomers including butyl acrylate and methyl methacrylate.

A typical film-forming polymer is comprised of one or more esters of acrylic or methacrylic acid, typically a mixture, e.g. about 50/50 by weight, of a high T_{g} monomer (e.g. methyl methacrylate) and a low T_{g} monomer (e.g. butyl acrylate), with small proportions, e.g. about 0.5% to about 2% by weight, of acrylic or methacrylic acid. The vinyl-acrylic polymers for example include vinyl acetate and butyl acrylate and/or 2-ethyl hexyl acrylate and/or vinyl versatate. In a typical vinyl-acrylic polymer, at least 50% of the polymer formed is comprised of vinyl acetate, with the remainder being selected from the esters of acrylic or methacrylic acid. The styrene/acrylic polymers are typically similar to the acrylic polymers, with styrene substituted for all or a portion of the methacrylate monomer thereof.

B. Gypsum Core

The gypsum core of the gypsum tile backer panel primarily comprises calcium sulfate material, along with any suitable additives.

A gypsum panel useful in the present invention comprises a gypsum core comprising greater than 75 weight % calcium sulfate material, typically at least 85 weight % calcium sulfate material, more typically at least 95 weight % calcium sulfate material. Generally the gypsum panel useful in the present invention comprises a gypsum core comprising greater than 75 weight % calcium sulfate dihydrate, typically at least 85 weight % calcium sulfate dihydrate, more typically at least 90 weight % calcium sulfate dihydrate, most typically at least 95 weight % calcium sulfate dihydrate.

A typical gypsum panel core is made from setting an aqueous gypsum slurry mixture having over 90 wt. %, more typically over 95 wt. % calcium sulfate hemihydrate (stucco) on a dry (water free) basis.

Suitable calcium sulfate material include any one or more of water-soluble calcium sulfate anhydrite, calcium sulfate alpha-hemihydrate, calcium sulfate beta-hemihydrate, natural, synthetic or chemically modified calcium sulfate hemihydrates, calcium sulfate dihydrate (“gypsum,” “set gypsum,” or “hydrated gypsum”), and mixtures thereof. As used herein, the terms “calcium sulfate” or “calcium sulfate material” refer to any of the forms of calcium sulfate referenced above.

Preferably the cores of the gypsum boards of the invention have less than 10 wt. % magnesium oxide. More preferably the cementitious cores of the gypsum boards and cement boards of the invention have less than 5 wt. % magnesium oxide. Most preferably the cementitious cores of the gypsum boards and cement boards of the invention have an absence of magnesium oxide.

The gypsum core can comprise paper or glass fibers, but is preferably substantially free of paper and/or glass fibers (e.g., comprises less than about 1 wt. %, less than about 0.5 wt. %, less than about 0.1 wt. %, or even less than about 0.05 wt. % of paper and/or glass fibers, or contains no such fibers). Preferably the gypsum core has an absence of cellulose.

Methods of Making Tile Backer Panels

Preferably the aqueous gypsum slurry comprises less than 10 wt. % magnesium oxide on a dry (water free) basis, preferably less than 5 wt. % magnesium oxide on a dry (water free) basis, most preferably an absence of magnesium oxide.

The gypsum core of the gypsum panel comprises set gypsum, namely calcium sulfate dihydrate resulting from setting the aqueous gypsum slurry comprising calcium sulfate hemihydrate and optionally calcium sulfate anhydrite.

Although the aqueous slurry being deposited is known as aqueous gypsum slurry the majority, generally at least 70 wt. %, of the calcium sulfate material it contains when deposited is calcined gypsum (calcium sulfate hemihydrate) which will set during processing to convert to gypsum (calcium dihydrate). Typically the aqueous gypsum slurry contains 75 to 100 wt. % reactive powder on a dry (water free) basis, to provide the aqueous gypsum slurry with at least 75 wt. % calcium sulfate material on a dry (water free) basis, preferably at least 75 wt. % calcium sulfate hemihydrate on a dry (water free) basis.

Typically when the calcium sulfate material and water are mixed the resulting aqueous gypsum slurry has at least 75 wt. %, preferably at least 85 wt. %, most preferably at least 95 wt. %, on a dry basis calcium sulfate hemihydrate. In other words, the aqueous gypsum slurry is at least 75 wt. %, preferably at least 85 wt. %, most preferably at least 95 wt. %, on a dry basis calcium sulfate hemihydrate prior to setting.

In the invention the cementitious slurry preferably does not entirely penetrate the first and second fibrous mats. Preferably, the cementitious slurry penetrates 30-60% of the thickness of each mat, more preferably 40-60% of the thickness of each mat.

The manufacturing method of the gypsum tile backer panels of the present invention typically involves placing a pre-coated bottom facing material (that will become the front facing) onto a conveyor belt, or onto a forming table that rests on the conveyer belt, and transporting the bottom facing material by the conveyor belt so that it passes underneath an aqueous gypsum slurry discharge. Then the method deposits the aqueous gypsum slurry (e.g., a mixture containing stucco and water, where stucco refers to calcined gypsum, typically comprised primarily of calcium sulfate hemihydrate and optionally calcium sulfate anhydrite) over the pre-coated first nonwoven mat facing material and covering the wet slurry. In particular, the aqueous slurry is typically discharged from a mixer through the mixer's discharge conduit or boot, which spreads the slurry on the bottom facing material. A typical method for preparing a gypsum tile backer panel of the invention can be conducted on existing gypsum board manufacturing lines used to make fibrous mat-faced cementitious boards known in the art. The aqueous gypsum slurry can be deposited onto the fibrous mat facing material in accordance with known methods and on existing manufacturing lines for preparing a fibrous mat-faced cementitious panel. Briefly, the process typically involves discharging a fibrous mat material onto a conveyor, or onto a forming table that rests on a conveyer, which is then positioned under the discharge conduit (e.g., a gate-canister-boot arrangement as known in the art, or an arrangement as described in U.S. Pat. Nos. 6,494,609 and 6,874,930) of a mixer. The components of the cementitious slurry are fed to the mixer comprising the discharge conduit, where they are agitated to form the cementitious slurry. Foam can be added in the discharge conduit (e.g., in the gate as described, for example, in U.S. Pat. Nos. 5,683,635 and 6,494,609).

Then, a moving, continuous top facing material (second nonwoven mat facing material that will become the rear facing) is placed on top of the aqueous gypsum slurry and bottom facing material through the use of another conveyor system. The second nonwoven mat facing material may be pre-coated or not coated. Thus, the aqueous gypsum slurry is sandwiched between the two mat facing materials to from a tile backer panel preform.

The tile backer panel preform then passes through a forming station, which forms the tile backer panel to the desired thickness and width. The tile backer panel then sets as the aqueous gypsum slurry is allowed to harden (e.g., set to form an interlocking matrix of calcium sulfate dihydrate, referred to as set gypsum) to produce a solid article prior to final drying in a kiln. In particular, the wet cementitious assembly thereby provided is conveyed to a forming station where the article is sized to a desired thickness, and to one or more knife sections where it is cut to a desired length to provide a cementitious board. The fibrous mat-faced gypsum panel is allowed to harden, and, optionally, excess water is removed using a drying process (e.g., by air-drying or transporting the fibrous mat-faced cementitious panel through a kiln). In particular, the gypsum tile backer panel travels along a belt line for several minutes, during which time the rehydration reaction occurs and the board stiffens. The gypsum tile backer panels are then cut into a desired length and fed into a large, continuous kiln for drying. During drying, the excess water (free water) is evaporated from the gypsum core while the chemically bound water is retained in the newly formed gypsum crystals.

Each of the above steps, as well as processes and equipment for performing such steps, are known in the art.

It also is common in the manufacture of cementitious building panels such as gypsum tile backer panels to deposit a relatively dense layer of slurry onto the first facing material before depositing the primary slurry, and to use vibration in order to eliminate large voids or air pockets from the deposited slurry. Also, hard edges, as known in the art, are sometimes used. These steps or elements (dense slurry layer, vibration, and/or hard edges) optionally can be used in conjunction with the invention.

Thus, optionally, a dense gypsum layer can be applied in between the core and the face mat, and optionally between the core and the back mat. For example, stucco and water are inserted into the main mixer, while foam is inserted downstream in the discharge conduit, meaning that foam is not inserted in the main mixer body. The main mixer can be a pin mixer or a pin-less mixer, as desired. A portion of the slurry, which is essentially foamless, is diverted from the mixer from an exit port generally opposite the discharge conduit to form the concentrated layer slurry. The main mixer acts as a pump to drive the unfoamed slurry out the smaller discharge port for the dense slurry which flows through the pressurized slurry line. Additives in wet form are injected into the pressurized slurry line through injection ports. The line is desirably long enough, which is within the level of ordinary skill, to allow for uniform mixing of slurry and additives. There is no need for separate introduction of stucco or water. If desired, two mixers can be used, with the second mixer for separately formulating a dense layer (skim coat or skim layer), e.g., with less or no foam, to be deposited between the core and one or both mats.

If desired to provide further water resistance to the fibrous mat-faced cementitious gypsum panel the method of making the fibrous mat-faced cementitious panel may further comprise (a) preparing an aqueous siloxane dispersion comprising about 4 wt. % to about 8 wt. % siloxane in water, and (b) combining the siloxane dispersion with the cementitious mixture to provide the cementitious slurry to be deposited onto a facing or other type of substrate, and subsequently allowed to harden, thereby providing the fibrous mat-faced cementitious panel.

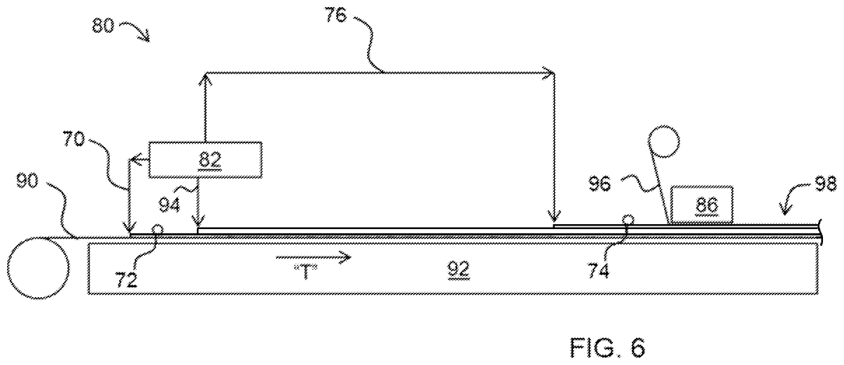

FIG. 6 illustrates an example of a wet end 80 (upstream portion) of a manufacturing production line for producing a layered tile backer panel of the present invention having a gypsum layer between two nonwoven glass fiber cover sheet.

The wet end 80 includes a gypsum slurry mixing and dispensing assembly 82 and a forming station 86. A first moving and web 90 of first coated nonwoven glass fiber cover sheet material (namely the material for the above-described front facing 5 having a pre-applied polymer coating and a hydrophobic material) which moves in a longitudinal direction of travel “T” along the forming table 92. The gypsum core slurry 94 is mixed in the gypsum slurry mixing and dispensing assembly 82 where additives and optional foaming of the slurry occurs. While the gypsum slurry mixing and dispensing assembly 82 is illustrated as a single component of the wet end 80, there can be multiple components that comprise the gypsum slurry mixing and dispensing assembly 82.

A first gypsum skim layer slurry 70 may be applied to the first cover sheet material 90 to form a gypsum skim layer on the first coated nonwoven glass fiber cover sheet material 90, and passes under a first gypsum skim coat roller 72, before depositing the gypsum core slurry 94. The gypsum skim layer is relatively denser than the gypsum core slurry which may be a foamed gypsum slurry. Thus, the gypsum core slurry 94 for the gypsum core layer of the tile backer panel is deposited onto either the first moving web 90 (e.g., to form the gypsum core) or the gypsum skim layer slurry 70, if applied.

A second moving web 96 of nonwoven glass fiber cover sheet material (namely the material for the above-described rear facing 6 which may be uncoated or coated with a pre-applied polymer coating and a hydrophobic finish) is applied to the gypsum slurry 94, or applied to the second skim lay slurry 76 if present as described below, and passed through the forming station 86 to compress the layers into a desired total thickness (e.g., about 0.25 inches to about 1.0 inches thick, preferably 0.25 inches to about 0.625 inches thick, The resultant structure is a tile backer panel preform 98.

Typically the outer surface of the applied moving web 96 is in contact with no additional layers.

Additional components can be included in the wet end 80 of the manufacturing line. For example, a calcined gypsum slurry 76 for forming a second skim layer may be applied to the layer of deposited gypsum core slurry 94, and then passes under a second gypsum skim coat roller 74. The first and second gypsum skim layers will typically be thinner and denser than the gypsum core layer. Typically the calcined gypsum (calcium sulfate hemihydrate) slurry for the gypsum core layer is foamed to be less dense than the slurry 70 of the first skim layer, as well as less dense than the slurry 76 of the second skim layer. Thus if desired, calcined gypsum core slurry stream 94 may pass through a former device (not shown), which for instance mixes the calcined gypsum core slurry stream 94 with foam and/or air, prior to deposition on the first coated nonwoven glass fiber cover sheet material 90. Typically the slurry streams for the gypsum skim layers 70, 76 have the same composition and density. However if desired, the slurry streams for the gypsum skim layers 70, 76 can have different compositions and/or densities. FIG. 6 shows both gypsum slurries 70, 76, 94 coming from the same calcined gypsum slurry mixing and dispensing assembly 82. However, the calcined gypsum slurries 70, 76, 94 can come from different mixing and dispensing assemblies to have different properties, such as different densities.

The first gypsum skim coat roller 72, the second gypsum skim coat roller 74, the forming table 92, the forming station 86 can all comprise conventional equipment suitable for their intended purposes as is known in the art. The wet end 80 can be equipped with other conventional equipment as is known in the art.

The calcined gypsum in the gypsum slurries 70, 76, 94 reacts with the water and sets as a conveyor moves the tile backer panel preform 98 down a manufacturing line. The tile backer panel preform 98 is dried and cut into segments of predetermined dimensions at a point along the line where the tile backer panel preform 98 has set sufficiently. The segments can be flipped over, dried (e.g., in a kiln) to drive off excess water, and processed to provide the final layered wallboard of desired dimensions.

The gypsum layer (including the core and skim layers) resulting from the set gypsum core slurries 70, 76, 94 generally has a thickness of 0.25 inches to 1.5 inches and an overall density of 15 to 55 pounds/cubic foot. When foamed, the portion of the gypsum core layer resulting from the set foamed gypsum slurry has a total void volume of 30 to 90 volume percent, preferably a void volume of 45 to 80 volume percent. The first skim layer and second skim layer (if present) resulting from setting the gypsum slurries 70, 76 have a total void volume of less than 30 volume percent, preferably less than 10 volume %.

System

Product according to the invention achieves water resistance and/or water barrier properties without compromising strength or flexibility of the product. Thus, product of the invention does not become too rigid or brittle, but rather achieves desirable mechanical properties such as nail-pull resistance, flexural strength, core hardness, end and edge hardness, surface water absorption, and/or humidified deflection in accordance with C1178/C1178M-18 Standard Specification for Coated Glass Mat Water-Resistant Gypsum Backing Panel 1.1. In addition, the shear bond strength of the panels of the invention (e.g., when bonded using set cement mortar or organic adhesive) exceeds about 50 psi when tested in accordance to the ASTM C1325 standard. This property is useful in some embodiments that can be used as substrates to bond ceramic tiles and stones using thin set cement mortars or organic adhesives.

Tile backer panel according to the present invention can be used in a number of interior and exterior applications, particularly where water resistance and especially waterproofness would be beneficial. For example, the tile backer panel might be useful in the installation of ceramic tiles and natural stone in wet and dry areas of buildings or other structures. Non-limiting examples of tile backer panel applications would include wet areas of buildings or other structures, such as in kitchens and bathrooms, including shower stalls, backsplashes, countertops, floors, and the like. In another aspect, the present disclosure is directed to a system comprising framing to which is attached at least one tile backer panel made according to the invention. In particular, the invention tile backer panel system of a building comprising framing to which is attached a plurality of tile backer panels, wherein the rear mat faces towards the framing.

Any of the tile backer panels described herein can be part of a system that includes a tile backer panel that is adhered to one or more wall studs via a fastener (e.g., a screw, a nail) with the rear mat facing the wall studs or ceiling joists.

Two adjacent panels are joined at the seams using a suitable joint tape and joint compound with water resistant properties. A preferred joint compound would be thin set mortar.

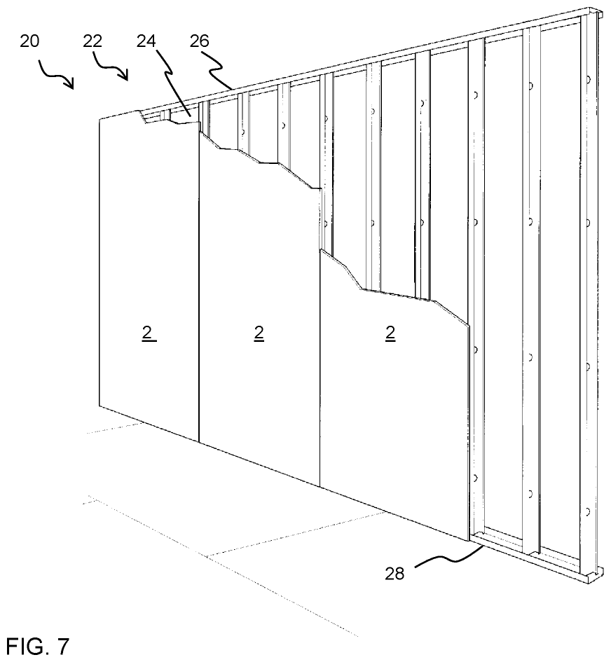

FIG. 7 is a perspective view of a tile backer panel system 20 that may be employed in the tile backer panel wall system. FIG. 7 shows the tile backer panel 2 of the present invention attached to one side of a metal stud wall, wherein the tile backer panel includes a gypsum panel (for example a panel of FIG. 2). FIG. 7 shows metal stud wall “skeleton” 22 which includes a plurality of metal studs 24, an upper track 26, a lower track 28. The tile backer panels 2 may be secured in any known manner to one or both sides of the metal studs 24 to close the wall and form the wall surface. This metal stud wall “skeleton” system is merely provided as illustrative as other metal frames may also be employed. Or a wood frame may be employed.

In the system the gypsum tile backer panels are typically attached to the framing by any one or more of screws, nails, or glue. Also, in the system the gypsum tile backer panel typically has no perforations except for perforations made by the screws or nails.

### Example

TABLE 1 shows comparative board formulations with the OC mat vs the standard Atlas mat tested for water resistance. The mats were made by applying the respective pre-coated and non pre-coated mats to respective gypsum cores.

TABLE 1
Formulations

| | Face mat used | |
|---|---|---|
| | Glass-Mat Sheathing | |
| | OC VL3580 | Comparative Glass- |
| Composition of slurry used to | Water resistant | Mat Faced |
| make gypsum core (lbs/MSF) | pre-coated mat | Sheathing |
| STUCCO | 1308.2 | 1265.9 |
| SOAP | 0.112 | 0.104 |
| Accelerator | 11.0 | 11.0 |
| STARCH | 16.0 | 16.0 |
| DISPERSANT | 8.5 | 8.6 |
| RETARDER | 0.2 | 0.2 |
| GLASS FIBER | 6.0 | 6.2 |
| TOTAL WATER | 1194.4 | 1142.3 |
| WATER:STUCCO WT. RATIO | 91.3 | 90.2 |
| sodium trimetaphosphate (STMP), | 12.0 | 12.0 |
| (water included wet basis) | | |
| SILOXANE | 4.9 | 5.0 |
| FLY ASH | 5.0 | 4.9 |
| BIOCIDE | 1.0 | 1.5 |

The water resistant OC VL3580 pre-coated mat is a coated mat having a product composition in a range (by weight %) of:
Continuous filament glass fiber 15-35% of the base mat
Calcium carbonate with traces of quartz mineral filler 45-75% as components of the mat coating
Cured acrylic polymer 2-10% coating
Cured urea-formaldehyde resin 2-10% uniformly distributed glass fiber binder

The comparative pre-coated glass mat has a product composition in a range (by weight %) of:
Continuous filament glass fiber 5-7%
Limestone Mineral filler 75-85%
Styrene butadiene rubber (SBR) polymer 3-6%
Cured acrylic polymer 4-7%
additional polymer 3-6%

In this example, a 24 inch water head was applied to three specimens of the USG Glass Mat Sheathing board. After 5 minutes, there was 0.20 inch, 0.60 inch, and 0.75 inch of water level drop for the three specimens. After two hours, the water level drop was 7.25 inch, 12 inch, and 12.50 inch, respectively. After 6 hours, the water level drop was 14.25 inch, 19.50 inch, and 20 inch, respectively. After 24 hours, water level drop was 21.50 inch, 24 inch, and 24 inch, respectively (a 24 inch water level drop means all water leaked out through the board). After 48 hours, there was 23″, 24″, and 24″ water level drop, respectively.

In this example, a 24 inch water head was also applied to the USG Trial board with the OC VL3580 coated mat. There was no water leakage after 48 hours (water level held constant during the test). This shows the benefit of a hydrophobic finish.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise specified all percentages and ratios are on a weight basis. As used herein, “molecular weight” in reference to a polymer or any portion thereof, means to the weight-average molecular weight (“Mw”) of the polymer or portion.

The invention is not to be limited by the above description but rather by the claims amended hereto.

1. A gypsum glass-mat tile backer panel comprising:
a gypsum core layer having front and rear surfaces, the gypsum core layer having a thickness of 0.25 to 1.25, wherein the gypsum core layer comprises at least 75 wt. % calcium sulfate material;
a first nonwoven fibrous mat having opposed first and second sides, the second side facing the gypsum core, wherein the second side of the first nonwoven fibrous mat is attached to the front surface of the gypsum core layer;
wherein the first nonwoven fibrous mat comprises at least one of polymer fibers, glass fibers, mineral fibers or a combination thereof, and a hydrophobic binder, wherein the hydrophobic binder comprises a first polymer, and optionally an inorganic filler, and optionally a second polymer binder;
wherein when deposited the mat has a surface water absorption of less than 0.5 grams per ASTM C1178/C1178M-18 Standard Specification for Coated Glass Mat Water-Resistant Gypsum Backing Panel 1.1;
a second nonwoven fibrous mat, wherein the second nonwoven fibrous mat is attached as a rear cover sheet to the rear surface of the gypsum core layer, wherein the second nonwoven fibrous mat comprises at least one of polymer fibers, glass fibers, mineral fibers or a combination thereof,
wherein the first and second nonwoven fibrous mats have an absence of paper fibers and an absence of cellulose fibers.

2. The panel of claim 1, wherein the hydrophobic finish (of polymer and filler) is 5-80% of the weight of the first nonwoven fibrous mat fibers and binder.

3. The panel of claim 1, wherein the slurry penetration into each said mat ranges from 30 to 60% of the respective mat thickness.

4. The panel of claim 1, wherein the slurry penetration into each said mat ranges from 40 to 60% of the respective mat thickness.

5. The panel of claim 1, wherein the cementitious core comprises a gypsum panel core layer comprising cementitious material comprising at least 85 weight % calcium sulfate dihydrate.

6. The panel of claim 1, wherein the hydrophobic material comprises film forming polymers, silanes, siloxanes, fluorides, or polymers with hydrophobic functional groups;
wherein the at least one film forming polymer is derived from at least one acrylic monomer selected from the group consisting of acrylic acid, acrylic acid esters, methacrylic acid, and methacrylic acid esters.

7. A method of making the panel of claim 1, comprising:
depositing a first nonwoven fibrous mat as a face mat onto a moving surface, wherein when deposited the first nonwoven fibrous mat has opposed first and second sides, the first side facing away from the moving surface;
wherein when deposited the first nonwoven fibrous mat comprises a substrate of non-woven fibers selected from at least one of polymer fibers, glass fibers, mineral fibers or a combination thereof, and a hydrophobic material pre-impregnated or pre-coated on the first nonwoven fibrous mat;
wherein when deposited the mat has a surface water absorption of less than 0.5 grams per ASTM C1178/C1178M-18 Standard Specification for Coated Glass Mat Water-Resistant Gypsum Backing Panel 1.1;
mixing at least water and calcium sulfate material to prepare an aqueous gypsum slurry comprising at least 75 wt. % calcium sulfate material on a dry (water free) basis, wherein said calcium sulfite material comprises calcium sulfate hemihydrate;
applying the aqueous gypsum slurry in a bonding relation to the second side of the first nonwoven fibrous mat to form a gypsum core layer, the gypsum core layer having a face side and a back side, wherein the gypsum core layer face side faces the face mat;
applying a second nonwoven fibrous mat as a back mat on the rear side of the gypsum core layer to form a board preform, thereby locating the aqueous slurry between the face mat and the back mat, wherein the second nonwoven fibrous mat comprises at least one of polymer fibers, glass fibers, mineral fibers or a combination thereof; and
allowing the aqueous gypsum slurry located between the face mat and the back mat to set, thereby forming the gypsum tile backer panel;
wherein the first and second nonwoven fibrous mats have an absence of paper fibers and an absence of cellulose fibers.

8. The method of claim 7, wherein the face mat is pre-impregnated by being filled or impregnated with the hydrophobic material with sufficient volume so as to impart the hydrophobic finish on the finished product.

9. The method of claim 7, wherein the pre-impregnated material has a microstructure that is a uniform distribution of the hydrophobic material or a gradient of the hydrophobic material from one surface of the face mat to an opposed surface of the face mat.

10. The method of claim 7, wherein the face mat is pre-coated with hydrophobic materials selected from at least one of film forming polymers, silanes, siloxanes, fluorides, or polymers with hydrophobic functional groups.

11. The method of claim 7, wherein the face mat is pre-coated with hydrophobic materials selected from at least one of silanes, siloxanes, and fluorides.

12. The method of claim 7, wherein the calcium sulfate material and water are mixed resulting in the aqueous gypsum slurry having at least 75 wt. % on a dry basis calcium sulfate hemihydrate, and wherein excess water is removed from the gypsum slurry by drying and rehydration which converts the calcium sulfate hemihydrate to the calcium sulfate dihydrate of a set gypsum core.

13. The method of claim 7, wherein the hydrophobic material is applied to the face mat while the face mat passes from a roll to the moving surface.

14. The method of claim 7, wherein the hydrophobic material is pre-applied to be on the face mat on a roll and the face mat passes from the roll to the moving surface.

15. A tile backer panel system of a building comprising framing to which is attached a plurality of said tile backer panels of claim 1, wherein the rear mat faces towards the framing, wherein the tile backer panel is on an exterior of the system.

16. A tile backer panel system of a building comprising framing to which is attached a plurality of said tile backer panels made according to claim 7, wherein the rear mat faces towards the framing, wherein the tile backer panel is on an exterior of the system.
